(19) United States
(12) Patent Application Publication
(10) Pub. No.: US 2013/0146319 A1
(43) Pub. Date: Jun. 13, 2013

(54) Multipurpose Lawn and Garden Tool

(71) Applicants: Art L. Truex, Bloomington, CA (US); Patricia C. Truex, Bloomington, CA (US)

(72) Inventors: Art L. Truex, Bloomington, CA (US); Patricia C. Truex, Bloomington, CA (US)

(21) Appl. No.: 13/705,225

(22) Filed: Dec. 5, 2012

Related U.S. Application Data
(60) Provisional application No. 61/568,757, filed on Dec. 9, 2011.

(51) Int. Cl. A01B 1/20

(52) U.S. Cl. CPC A01B 1/20
USPC 172/378

(57) ABSTRACT

Disclosed is a multipurpose garden tool having an elongated handle and a head implement. The head comprises a braced handle portion securing the backside of an upstanding body portion, below which extends a plurality of offset rake tines. The implement is largely rectangular and includes a curved lower region. The upper portion forms an elongated leveling edge or a hula hoe device for scraping, leveling, cutting and distributing soil. The lower edge forms a rake tool having elongated tines for separated and lifting soil. The leftmost short edge forms a pointed blade for chopping, prying and furrowing soil. Finally, the rightmost short edge forms a square blade edge for shearing and chopping operations. The tines are offset from the upper body region to increase soil penetration and debris separation while raking. Finally, a plurality of holes may further be placed through the body region for use as a shearing tool.

### CROSS REFERENCE TO RELATED APPLICATION

This application claims the benefit of U.S. Provisional Application No. 61/568,757 filed on Dec. 9^{th}, 2011, entitled “Yardyho.” The above identified patent application is herein incorporated by reference in its entirety to provide continuity of disclosure.

### BACKGROUND OF THE INVENTION

1. Field of the Invention

The present invention relates to garden hand tools. More specifically, the present invention relates to multipurpose implement for use as a hoeing tool, garden tiller, general landscaping device, and forestry or firefighting tool.

For professional landscapers, farmers and homeowners, working the land for a specific goal can take many operations and many tools depending on the project. Farming and gardening users generally prepare the soil by establishing rows of buried seeds and removing weeds throughout the season. Landscaping users trim and clean the edges of the property for aesthetic purposes. And home owners and utility workers dig trenches to lay utility cables or piping across properties. Each of these tasks requires specific tools and operations to accomplish effectively. This often requires the user to operate many different tools in succession before the task or goal is completed. The activity itself can be hindered by the fact one may not possess all of the necessary tools to accomplish the given project, or likewise the efficiency of the project may be hindered by the constant switching between tools.

The present invention provides a multi-use and multipurpose hand tool that facilitates common lawn and gardening operations using a single tool. The device comprises a rake or hoe implement positioned along the distal end of an elongated handle. The implement includes features that allow it to operate as a garden hoe, a rake, a shovel, a leveler, furrowing tool, edger and prying tool. Elongated and sharpened edges along the tool allow the device to excavate soil, separating stones and weeds in the process. One end of the device includes a sharpened point such that the end can act as a pointed shovel device for penetrating soil and lifting stubborn objects buried in the ground. This end can further be used for cutting, scraping, and cleaning hard to reach edges and corners. Rake tines are provided in an offset and elongated fashion to facilitate weed removal and soil spreading, while the upper portion further provides a long and flat surface for leveling soil or chopping weeds. Overall, the device provides several functions in one implement, where the elements are uniquely positioned and designed to facilitate use in lawn and garden work. A further use of the present invention is in the field of forestry and firefighting, where trench digging and soil operations are necessary to stem the spread of fires in a given environment.

2. Description of the Prior Art

Devices have been disclosed in the prior art that relate to garden tool device. These include devices that have been patented and published in patent application publications, and generally relate to modified garden hoe tools and multipurpose garden tools. The following is a list of devices deemed most relevant to the present disclosure, which are herein described for the purposes of highlighting and differentiating the unique aspects of the present invention, and further highlighting the drawbacks existing in the prior art.

Specifically, U.S. Published Patent Application Publication Number 2003/0159841 to Hall discloses a combined garden tool that includes a weed remover, a pointed or flat trenching tool and a soil leveler tool. The weed removal tool includes a set of elongated and parallel tines having pointed ends. The trenching tool is positioned opposite of the weed removal tool, and comprises a singular pointed implement for piercing a soil surface. Finally, the soil leveler tool comprises a flat blade section between the opposing tines and trenching tool, whereby the tool can be pulled in an orthogonal direction to the tine and trenching tool directions. The device of Hall includes a multipurpose tool having similar elements, but fails to disclose all features of the present tool.

Another such device is U.S. Pat. No. 5,452,769 to Markert, which discloses a multipurpose garden tool having a hexagonally shaped blade head for conducting different gardening and landscaping activities. A plurality of teeth are provided along one edge for removing weeds, while an opposing straight portion is utilized for hoeing purposes. Along the ends of the device are a first and second pointed portion, the first of which being utilized for digging and removing rocks. The second pointed end includes a cutting edge and a flap skid bent at an angle with respect to the second end to create a defined furrow depth while furrowing. The device is adapted to be supported by an elongated handle in a similar fashion as the present invention; however the elements of the Markert device diverge from those of the present invention.

Further, U.S. Pat. No. 5,025,621 to DeMarco discloses a combination garden cultivating and pruning device having an implement head comprising a generally rectangular shape and four cultivating implements thereon. The pruning devices include a rake member, a sifter member, a hoe member and a cultivator. Within the handle of the device is a detachment for using in pruning, wherein a set of shears is deployable from the handle to provide a user with a tool having a four-purpose tool head and a 5-purpose overall device when including the removable shears. While disclosing a multipurpose gardening implement, the present invention provides a variation as to the elements disclosed on the tool head that differentiate itself from the DeMarco device. The present invention further does not require a handle having a pair of deployable shears.

Finally, U.S. Pat. No. 3,930,544 to Foster, Sr. discloses a garden cultivation implement having a plurality of cutting edges for weed removal and cutting of undesired growth while landscaping. Similar to the DeMarco device, the Foster, Sr. device comprises a rectangular implement having elongated horizontal edges and shorter vertical edges. Tapering tines are provided along the lower horizontal edge, while the upper horizontal edge provides a cutting edge. The shorter edges or ends of the implement terminate in wing portions rising above and from the upper horizontal cutting edge to form inclined-sharp edges. The two side edges are mirror images of one another in structure, while the implement as a whole secures to an elongated handle for the user to grip and handled the device. The Foster, Sr. device is one having several cutting edges and a set of tines. The present invention provides an asymmetrical layout that provides different functions on opposing ends of the implement for increasing the number of cultivation functions provided by a single tool.

The present invention provides several functions in a single tool. The device includes an implement that serves as a garden hoe, rake, shovel, furrowing tool, chopping implement, scraping and prying tool all in a single device. It is submitted that the present invention is substantially divergent in design elements from the prior art, and consequently it is clear that there is a need in the art for an improvement to existing lawn and garden tool devices. In this regard the instant invention substantially fulfills these needs.

### SUMMARY OF THE INVENTION

In view of the foregoing disadvantages inherent in the known types of lawn and garden tool devices now present in the prior art, the present invention provides a new multipurpose lawn and garden tool that can be utilized for providing convenience for the user when landscaping, gardening or working on a property.

It is therefore an object of the present invention to provide a new and improved lawn and garden device that has all of the advantages of the prior art and none of the disadvantages.

It is another object of the present invention to provide a lawn and garden device to provide a tool having several features to be utilized independently from one another without switching tools between tasks.

Another object of the present invention is to provide a lawn and garden device that includes a beveled set of elongated rake tines to improve ground penetration, soil separation and raking functions.

Yet another object of the present invention is to provide a lawn and garden device that may be provided in a number of different sizes to suit a particular set of tasks or a particular user need.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective end view of the present invention.

FIG. 2 shows a side view of the present invention.

FIG. 3 shows an end view of the present invention.

FIG. 4 shows an overhead view of the present invention.

FIG. 5 shows a perspective end view of an embodiment of the present invention.

### DETAILED DESCRIPTION OF THE INVENTION

Reference is made herein to the attached drawings. Like reference numerals are used throughout the drawings to depict like or similar elements of the multipurpose lawn and garden tool. For the purposes of presenting a brief and clear description of the present invention, the preferred embodiment will be discussed as used for accomplishing several lawn, garden and forestry tasks without switching between tools. The figures are intended for representative purposes only and should not be considered to be limiting in any respect.

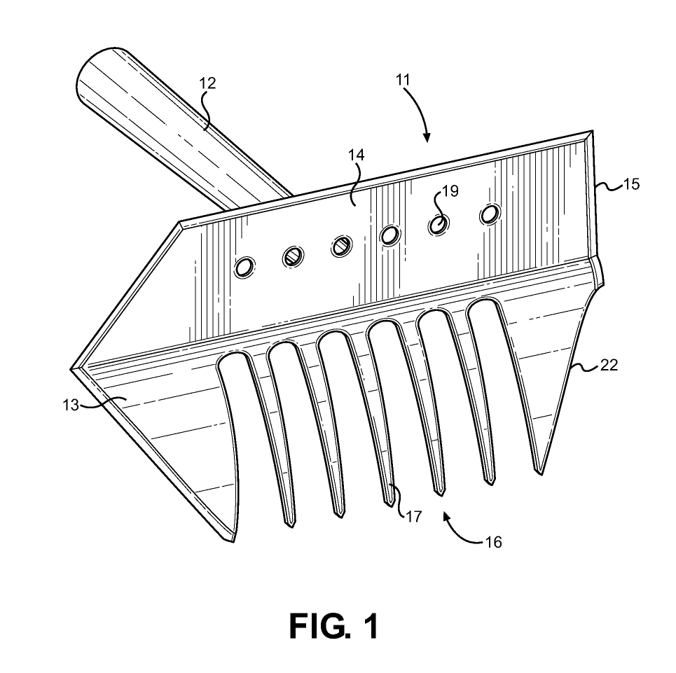

Referring now to FIG. 1, there is shown a perspective end view of the multipurpose lawn and garden tool of the present invention. The device comprises an implement 11 that attaches to the distal end of an elongated rake or shovel handle by way of a braced receiving sleeve 12. The implement 11 comprises several functions that are incorporated into a single tool head such that tool switching is minimized during a lawn or garden project, while also reducing tool count and time spent switching between tools. The primary objects of the tool are to provide a combination rake, hoe, hatchet, scraper, soil spreader/leveler and shovel tool combined into a single unit. The implement itself is a largely rectangular shape having an upstanding upper portion 14 and a beveled or curved lower portion 16. The upper and lower edges of the implement comprise the long edges of the rectangular shape, while the handle receiving sleeve 12 is positioned along the backside surface of the implement 11. The upper portion 14 comprises a body section and flat, sharpened upper edge for soil leveling purposes, as well as scraping and cutting small weeds and grasses. The lower portion 16 comprises a plurality of tines 17 that function as a rake tool for separation of articles within the soil. To operate either of these elements, the tool can be flipped over as required to place the upper or lower portion in contact with the soil surface.

The implement first short side 13 comprises a pointed and sharpened region for use as a furrowing or shovel tool. Angled edges form together to create a pointed shovel blade for ground penetration and for gaining access under buried articles within the soil. The user is free to swing the tool by the handle for the purpose of penetrating and disturbing soil with this pointed shovel end 13. The pointed end 13 is also useful for scraping, cutting and cleaning hard to reach edges. The second short side 15 of the implement 11 comprises a sharpened, squared edge that functions as a small hoe tool. Similar to the shovel end 13, this second end includes a sharpened edge that can be thrust into a ground surface for separating soil, removing weeds, chopping small branches and roots, and digging trenches. Both sides may be utilized as a furrowing tool or trenching tool. Finally, small apertures 19 through the upper portion of the tool can be created to reduce the overall weight of the device or for providing a shearing or bending tool for branches, wires and rods, whereby the interior edge of each aperture 19 is utilized to bend, break, or shear branches and other articles.

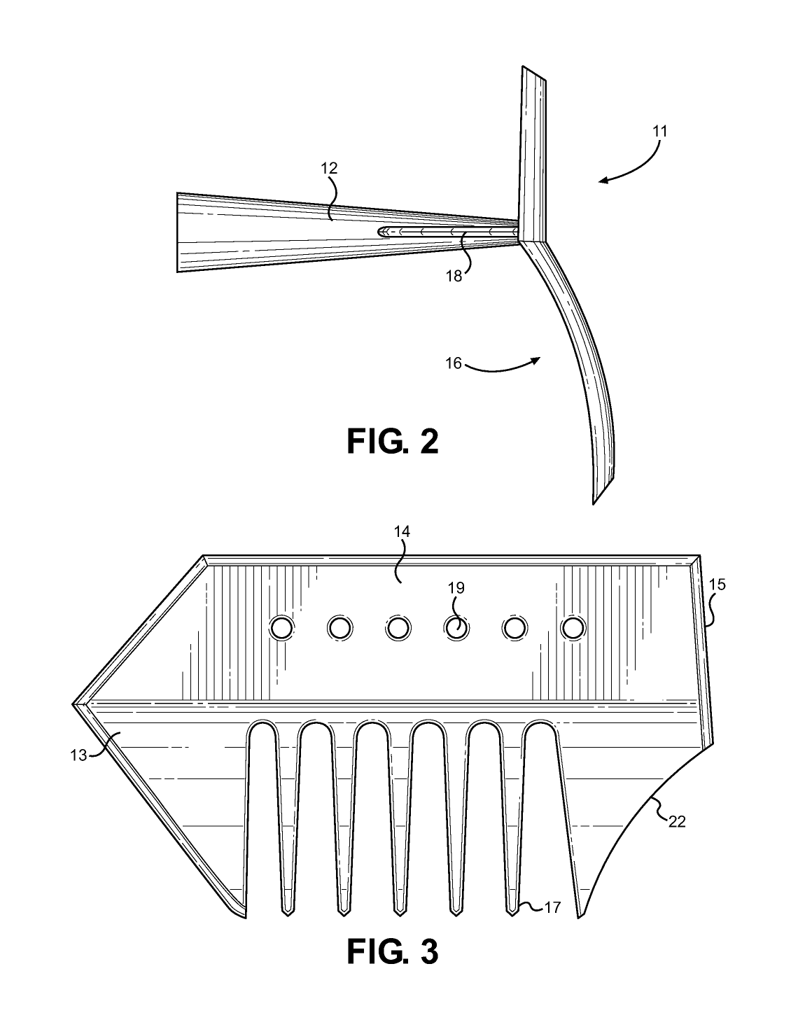

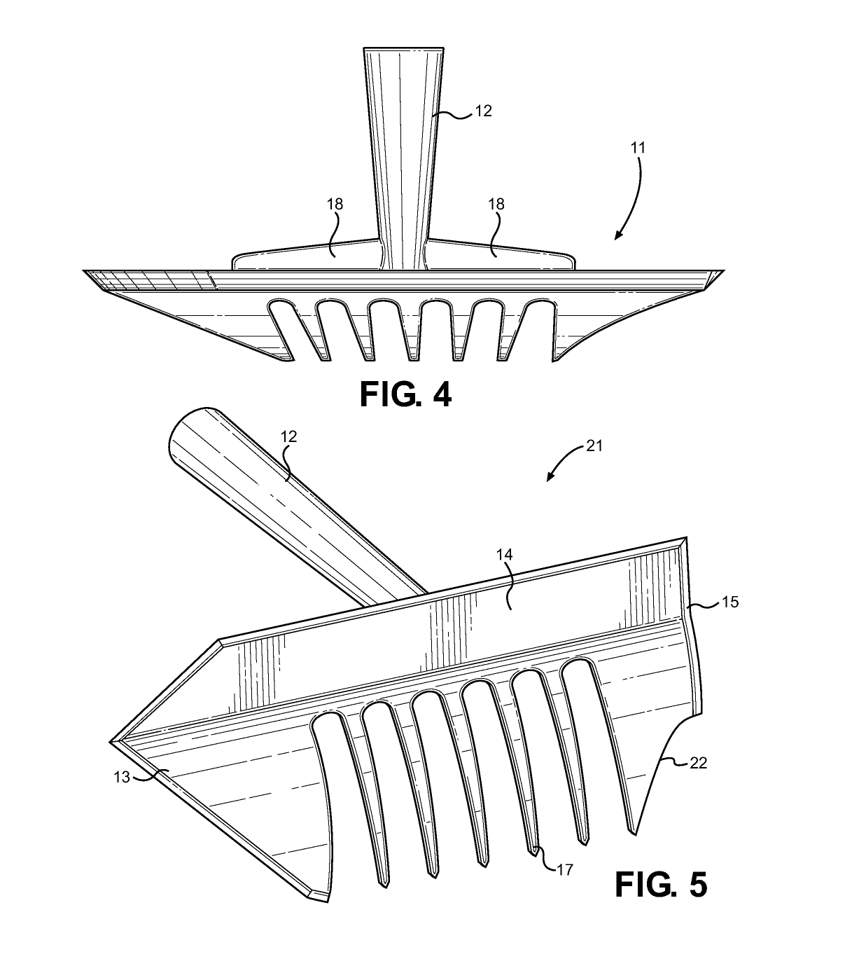

Referring now to FIGS. 2 and 4, there is shown a side view and an overhead view of the present garden tool implement of the present invention. The angle of the lower portion 16 and its offset design is visualized, whereby the offset improves the ability of the tines to penetrate the soil when the user is operating the device, improving separation of weeds from the soil and efficiency of the tool. The rear portion of the device includes a handle sleeve 12 and reinforcement 18 to prevent the tool 11 from separating from the sleeve 12 or the handle during use. The reinforcement increases the rigidity and stiffness of the sleeve length 12 to prevent yielding or bending of this area.

Referring now to FIG. 3, there is shown an end view of the present invention, wherein the length of the tines 17 and the transition between the second short side 15 and the tines 17 is visualized. The second short side 15 is a flat hoe blade, which transitions to an outermost tine 22 along the lower portion of the implement. The length of the tines allows for improved ground penetration and separation, while the thickened outer tine prevents bending of this element upon impact of the second short side 15 with the soil. The elongated and flat upper portion 14 serves as a leveling, scraping and cutting tool, while the shovel 13 and hoe 15 ends provide two ground-penetrating implements for article removal, chopping, cutting and trench digging functions.

Referring finally to FIG. 5, a perspective end view of the present invention is shown for the purposes of highlighting an embodiment 21 that contemplates varying dimensions for the device upper portion 14. In this embodiment, the upper portion 14 is shorter for improved control while leveling, scraping and cutting. The core functions of the implement are retained, including the shovel or furrow end 13, flat hoe tool end 15, raking tool lower portion 17 and flat, leveling upper portion 14. In operation, the device operates either as a rake, leveler or soil furrowing/hoeing/chopping tool. The device includes sharpened edges for use as a hoe for chopping weeds, while the shovel end 13 functions as a shovel or a wedge for furrowing and chopping. The top side of the device includes a sharpened edge for leveling and smoothing an area, or further for scraping weeds like a hula hoe or wide hoeing blade. The rake itself has elongated tines for separating grasses from dirt, while their design is arcuate or beveled outward from the upper portion to facilitate separation and efficiency during use. A user handle is connected to the implement sleeve 12 and braced to accommodate the loads imparted on the tool during use. The material of the tool may be one of heavier construction for improved leverage during hoeing or chopping operations, or of a lighter construction for improved handling and transport.

When engaging in any kind of yard work, whether professionally or privately, it can be a troublesome to carry around many tools or switch tools between operations. Before even starting, individuals may search their garages or tool sheds to find the necessary tools for the job at hand. They then need to transport these tools to a convenient location so they can be easily accessed while working. If individuals are required to continually swap tools, they set their current tool back in the pile, grab the one they need, and then go back to what they were doing. This entire process can be exhausting and inconvenient. Additionally, it can be expensive to buy and store separate gardening tools. The present invention provides individuals with an all-in-one tool that can be used by landscapers, gardeners, firefighters, forestry personnel or homeowners. The device resembles a long-handled garden hoe or shovel tool with a multi-use head that can allow the user to rake, chop, furrow, level, and smooth a yard or garden. By using this device in lieu of multiple, disparate tools, individuals will not be required to haul around and carry multiple heavy tools.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A multipurpose lawn and garden tool, comprising:
an implement having a handle receiving portion connecting to a body region having an upstanding upper region, an arcuate lower region and a first and second side portion;
said upstanding upper region having a flat upper edge;
said lower region comprising a plurality of arcuate rake tines that angle out of plane from said flat upper region;
said first side portion comprising a first and second sharpened edge forming a pointed tool shape;
said second side portion comprising a square edge with respect to said upper portion to form a tool edge.

2. The device of claim 1, wherein said upper portion further comprises a plurality of apertures for weight reduction.

3. The device of claim 1, wherein said upper portion further comprises a plurality of apertures for providing a shearing and bending tool.

4. The device of claim 1, wherein said handle receiving portion further comprises a handle sleeve and reinforcement elements to prevent separation of said sleeve and said implement body region.
